(19) United States
(12) Patent Application Publication
(10) Pub. No.: US 2024/0335824 A1
(43) Pub. Date: Oct. 10, 2024

(54) A METHOD OF SYNTHESIZING A LOW SAR CHABAZITE ZEOLITE AND THE ZEOLITE OBTAINED THEREBY

(71) Applicant: JOHNSON MATTHEY PUBLIC LIMITED COMPANY, London (GB)

(72) Inventors: Sanyuan YANG, Savannah, GA (US); Alessandro TURRINA, Billingham (GB); Logan SPELL, Savannah, GA (US); Daniel GILLELAND, Savannah, GA (US)

(21) Appl. No.: 18/293,533

(22) PCT Filed: Jun. 16, 2022
(86) PCT No.: PCT/GB2022/051523

§ 371 Date: Jan. 30, 2024

Related U.S. Application Data
(60) Provisional application No. 63/203,781, filed on Jul. 30, 2021.

(51) Int. Cl. B01J 29/76; B01D 53/94; B01J 37/00; B01J 37/03; B01J 37/30; C01B 39/48

(52) U.S. Cl. CPC B01J 29/763; B01D 53/9418; B01J 37/0018; B01J 37/031; B01J 37/036; B01J 37/30; C01B 39/48; B01D 2255/20738; B01D 2255/20761; B01D 2255/50; B01D 2255/9202; B01D 2255/9205; B01D 2255/9207; B01D 2257/404; B01D 2258/01; B01J 2229/186; C01P 2002/60; C01P 2002/72; C01P 2004/03; C01P 2006/12; C01P 2006/14

(57) ABSTRACT

A low SAR chabazite zeolite, its synthesis, and its use for the treatment of an exhaust gas, are disclosed. The chabazite (CHA) zeolite having an SAR of from 7 to 15, and at least one following features: (a) a mesoporous surface area of less than 35 m² (b) a BET surface area of 500-800 m²/g; and/or (c) a micropore volume of 0.2-0.3 cm²/g.

### FIELD OF THE INVENTION

The present invention relates to a chabazite (CHA) zeolite. More particularly, the present invention relates to a chabazite zeolite having a silica-alumina ratio (SAR) of from 7 to 15. The present invention also relates to a method for the manufacture of a chabazite zeolite, specifically a zeolite having an SAR of from 7 to 15. The present invention further relates to a catalyst article comprising a chabazite zeolite and a method for the treatment of an exhaust gas which comprises contacting an exhaust gas with a catalyst article comprising a chabazite zeolite.

### BACKGROUND OF THE INVENTION

NH₃—SCR is the most effective technique for NOx abatement in lean-burning engine exhaust after-treatment. In this regard, Cu—SSZ-13 has been commercialized as an NH₃—SCR catalyst for its significant advantages of excellent catalytic performance and hydrothermal stability. However, with more and more stringent restrictions imposed on emissions from engine exhausts, especially for vehicles under cold start conditions, further enhancing the low-temperature NH₃—SCR activity and hydrothermal stability of SCR catalysts is highly desirable.

Small pore zeolites like CHA and AEI with low silica to alumina ratio (SAR) usually have a higher fresh activity but lower durability than high SAR framework under comparable SCR working conditions. To improve the overall performance of low SAR structures, it is necessary to enhance the durability and/or to improve NOₓ conversion performance.

It is known that CHA zeolites with an SAR of lower than 5.5 can be made by several known methods without the use of a structure directing agent (SDA). However, CHA with such a low SAR is not suitable for many applications due to the low stability associated with low framework SAR or partial structure collapse after stabilization treatment. CHA with an SAR of from 8 to 10 could be directly synthesized as described in Journal of Catalysis 365 (2018) 94-104, for example. These reported synthesis methods required the use of a large amount of CHA seeds relative to the formed product. The seeds were made with use of an organic SDA (OSDA) and the calcination burned off the OSDA content before use.
WO 2019/213027 A1 relates to low-silica chabazite zeolites with high acidity.
WO 2019/180663 A1 relates to CHA zeolite material and related method of synthesis.

There remains a need in the art of improved CHA zeolites which exhibit greater hydrothermal stability and/or improved NOₓ conversion (e.g., at low temperature, either fresh or aged) for use in NOₓ abatement catalysts in the selective catalytic reduction of NOₓ, and their methods of manufacture thereof.

### SUMMARY OF THE INVENTION

One aspect of the present disclosure is directed to a chabazite (CHA) zeolite having an SAR of from 7 to 15, and at least one following features: (a) a mesoporous surface area of less than 35 m²/g; (b) a BET surface area of 500-800 m²/g; and/or (c) a micropore volume of 0.2-0.3 cm²/g.

Another aspect of the present disclosure is directed to a method for the manufacture of a chabazite (CHA) zeolite having an SAR of from 7 to 15, the method comprising:
(i) forming a reaction gel comprising a structure directing agent (SDA), sodium and/or potassium hydroxide, a silica source and an alumina source, and
(ii) heating the gel to a temperature and for a duration suitable for the growth of the CHA zeolite,
wherein, relative to a molar amount of Al₂O₃ equivalent, the gel comprises from 0.1 to 2 moles of the SDA, and wherein the SDA cation is N,N,N-trimethyladamantylammonium.

Another aspect of the present disclosure is directed to a catalyst article for the treatment of an exhaust gas, the catalyst article comprising the CHA zeolite as described herein.

Another aspect of the present disclosure is directed to a method for the treatment of an exhaust gas, the method comprising contacting an exhaust gas with the catalyst article described herein.

### BRIEF DESCRIPTION OF THE DRAWINGS

FIG. 1 shows powder X-ray diffraction (XRD) patterns of the as-synthesized CHA structure made in Examples 1-5 compared to a simulated pattern for an ideal Silicon oxide CHA framework.

FIG. 2 shows powder X-ray diffraction (XRD) patterns of the as-synthesized CHA structure made in Examples 6-10 compared to a simulated pattern for an ideal Silicon oxide CHA framework.

FIG. 3 shows powder X-ray diffraction (XRD) patterns of the as-synthesized CHA structure made in Examples 11-16 compared to a simulated pattern for an ideal Silicon oxide CHA framework.

FIG. 4 shows powder X-ray diffraction (XRD) patterns of the activated CHA structure made in Examples 12-14.

FIG. 5 shows powder X-ray diffraction (XRD) patterns of the as-synthesized CHA-GME intergrowth structure made in Comparative Example 1.

FIGS. 6-1 to 6-17 provide SEM images of the products obtained in Examples 1-16 and Comparative Example 1 at different magnifications.

FIG. 7 shows the NOₓ conversion activity of the fresh and aged catalysts of Example 12 and Comparative Catalyst 1 tested at temperatures of 150 to 500° C. with a ramp rate of 5° C. per minute.

FIG. 8 shows the NOₓ conversion activity of the fresh and aged catalysts of Example 13 and Comparative Catalyst 2 tested at temperatures of 150 to 500° C. with a ramp rate of 5° C. per minute.

FIG. 9 shows the NOₓ conversion activity of the fresh and aged catalysts of Example 14 and Comparative Catalyst 2 tested at temperatures of 150 to 500° C. with a ramp rate of 5° C. per minute.

### DETAILED DESCRIPTION OF THE INVENTION

A first aspect of the present invention is directed to a chabazite (CHA) zeolite having an SAR of from 7 to 15, and at least one following features: (a) a mesoporous surface area of less than 35 m²/g; (b) a BET surface area of 500-800 m²/g; and/or (c) a micropore volume of 0.2-0.3 cm²/g.

The present disclosure will now be described further. In the following passages, different aspects/embodiments of the disclosure are defined in more detail. Each aspect/embodiment so defined may be combined with any other aspect/embodiment or aspects/embodiments unless clearly indicated to the contrary. In particular, any feature indicated as being preferred or advantageous may be combined with any other feature or features indicated as being preferred or advantageous.

Zeolites are structures formed from alumina and silica and the SAR determines the reactive sites within the zeolite structure. Small-pore zeolites, including CHA-type zeolites, possess pores that are constructed of eight tetrahedral atoms (Si⁴⁺ and Al³⁺), each time linked by a shared oxygen These eight-member ring pores provide small molecules access to the intracrystalline void space, e.g., to NOₓ during car exhaust cleaning (NOₓ removal) or to methanol en route to its conversion into light olefins, while restricting larger molecule entrance and departure that is critical to overall catalyst performance. A CHA zeolite may also be referred to as a zeolite having a CHA framework structure as is known in the art.

Preferably, the CHA zeolite of the present invention has an SAR of at most 14, preferably at most 13, preferably at most 12, more preferably at most 11 and even more preferably at most 10. It is also preferred in some embodiments that the CHA zeolite has an SAR of at least 8 or at least 9. In some embodiments, it is preferred that the CHA zeolite has an SAR of from 7 to 14, 7 to 13, 7 to 12, 7 to 11, or 7 to 10. In other embodiments described herein, the SAR is preferably from 8 to 15, 8 to 14, 8 to 13, 8 to 12, 8 to 11, or 8 to 10. In yet other embodiments, the SAR is preferably from 9-15, 9 to 14, 9 to 13, 9 to 12, 9 to 11, or 9 to 10.

In combination with the desired SAR, the present invention provides a CHA zeolite having a mesoporous surface area of less than 35 m²/g, preferably no greater 30 m²/g, more preferably no greater than 25 m²/g. In some embodiments, the CHA zeolite can have a mesoporous surface area of no greater than 10 m²/g. In certain embodiments, the CHA zeolite can a mesoporous surface area of 1-35 m²/g, 2-35 m²/g, 2-30 m²/g, or 2-25 m²/g, 2-20 m²/g, or 2-10 m²/g. This unique combination of features has been achieved as a result of the unique synthetic methodology described herein. In particular, the present inventors have identified specific gel formulations which enable the production of CHA zeolites with the desired SAR as described herein together with a mesoporous surface area of less than 35 m²/g. The resulting zeolites provide for NH₃—SCR catalysts with improved performance.

Mesoporous surface area may be measured using any conventional technique in the art. For example, by measuring the Ar or N₂ adsorption isotherms on the activated samples at 87 or 77 K, respectively, according to the Brunauer-Emmett-Teller (BET) method. Prior to measurement the samples are heated under vacuum to remove physiosorbed water. The pore size distributions are measured by the nonlocal density functional theory (NLDFT). The mesopore surface area is calculated by the difference between the apparent BET and the micropore surface areas.

In combination with any of the desired features as described above, the present invention provides a CHA zeolite having a BET surface area of 500-800 m²/g; preferably, 600-800 m²/g; or more preferably, 650-800 m²/g.

In combination with any of the desired features as described above, the present invention provides a CHA zeolite having a micropore volume of 0.2-0.3 cm²/g; preferably, 0.22-0.28 cm²/g; or more preferably, 0.23-0.26 cm²/g.

Preferably, the CHA zeolite has a crystallinity of greater than 95%.

Preferably, the CHA zeolite has a granular particle. That is, it is preferred that the zeolite has a particulate morphology whereby the zeolite crystals have a three dimensional shape in contrast to rod like particles having a substantially one dimensional shape or disk or plate like particles having a two dimensional shape. It is preferred that the zeolite has a granular particle comprising or consisting of cubic crystals.

Preferably, the CHA zeolite has a mean longest edge crystal size of no greater than 6 microns, preferably, no greater than 5 microns. In some embodiments, the CHA zeolite can have a mean longest edge crystal size of 0.1-6 microns, preferably, 0.1-5 microns, or 0.2-5 microns. In further embodiments, the CHA zeolite can have a mean longest edge crystal size of 0.5-6 microns, 0.5-5 microns, or 0.5-4 microns. Such an average crystal size may be determined using standard microscopic techniques such as scanning electron microscopy (SEM). The measurement is taken over a statistically meaningful portion of the zeolites produced.

In one particularly preferred embodiment, the CHA zeolite is an iron and/or copper exchanged zeolite. Such transition metal exchanged zeolites are particularly effective as catalysts for the abatement of NOₓ in NH₃—SCR catalysts.

In a further aspect of the present invention, there is provided a method for the manufacture of a chabazite (CHA) zeolite having an SAR of from 7 to 15, the method comprising:
(i) forming a reaction gel comprising a structure directing agent (SDA), sodium and/or potassium hydroxide, a silica source and an alumina source, and
(ii) heating the gel to a temperature and for a duration suitable for the growth of the CHA zeolite,
wherein, relative to a molar amount of Al₂O₃ equivalent, the gel comprises from 0.1 to 2 moles of the SDA, and wherein the SDA cation is N,N,N-trimethyladamantylammonium.

It is particularly preferred that the method described herein is for making the CHA zeolite described in the first aspect of the present disclosure.

The method of the invention involves forming a reaction gel which may also simply be referred to as a reaction mixture. Such reaction gels are well known in the art of zeolite synthesis. The reaction gel comprises a structure directing agent (SDA), sodium and/or potassium hydroxide, a silica source and an alumina source.

Synthesis of zeolite crystals typically involves reacting alumina and silica in the presence of an organic template (also referred to as a structure directing agent or SDA; similarly, SDA cations can be referred to as SDA) at elevated temperatures for several days. During crystallization, the alumina and silica co-join to form a crystalline structure around the SDA. The reactants, reaction conditions, and the species of SDA all impact which type or types of framework that are synthesized. When sufficient crystallization has occurred, the crystals are removed from the mother liquor and dried. After the crystals are separated from the mother liquor, the organic SDA is thermally degraded and removed from the crystalline structure, thus leaving a porous molecular sieve.

The SDA cation for use in the method is N,N,N-trimethyladamantylammonium (TMAd⁺), which is also known as an organic SDA cation. The SDA cation of the present invention is typically associated with anions which can be any anion that is not detrimental to the formation of the zeolite. Representative anions include elements from Group 17 of the Periodic Table (e.g., fluoride, chloride, bromide and iodide), hydroxide, acetate, sulfate, tetrafluoroborate, carboxylate, and the like.

The reaction gel is formed by the addition of one or both of sodium hydroxide and potassium hydroxide. Where only one of sodium and potassium hydroxide are used to form a reaction gel, sodium hydroxide is preferred.

The reaction gel further comprises a silica source and an alumina source. That is, the reaction gel is formed by the addition of a source of SiO₂ and a source of Al₂O₃ as is known in the art. Preferably, the source of silica is one or more of sodium silicate, potassium silicate, silica gel, silica sol, fumed silica, silicon alkoxides, and precipitated silica, preferably silica sol. Silica sol is a colloidal suspension of silica in water. Preferably, the source of alumina is one or more of sodium aluminate, aluminum salts such as aluminum sulfate, aluminum nitrate, aluminun chloride, aluminum hydroxide, aluminum alkoxides, and alumina, preferably one or more of aluminum hydroxide and aluminum sulfate. In other preferred embodiments, the silica source and the alumina source may comprise the same material, for example, silica-alumina or zeolites such as FAU or USY framework zeolites.

Preferably, the alumina source is selected from FAU zeolite, USY zeolite, Al(OH)₃, and Al₂(SO₄)₃. As will be appreciated, when the alumina source comprises, for example, FAU or USY zeolite, the zeolite will also act as a silica source. In such embodiments, it is still preferred that the silica source comprises a further source of silica as described above, preferable silica sol.

As is known in the art, the reaction composition may be described in terms of the equivalent amount of SiO₂, Al₂O₃, M₂O (where M is Na and/or K), SDA, and H₂O present in the reaction gel. In other words, the reaction gel composition may be described by the ratio: Al₂O₃: aSiO₂: bSDA: cM₂O: dH₂O wherein the reaction composition is normalised to a molar amount (1 mole) of Al₂O₃ equivalent. As will be appreciated, the scale of the reaction and the absolute number of moles may vary.

The method of the present invention comprises forming a reaction gel whereby, relative to the molar amount of Al₂O₃ equivalent (i.e. 1 mole of Al₂O₃, which is provided by the alumina source, such as 2 moles of Al(OH)₃), the gel comprises from 0.1 to 2 moles of the SDA. The present inventors have found that such a relatively low amount of SDA (TMAdOH), allows for the synthesis of the advantageously low SAR zeolite as described herein. Preferably, relative to the molar amount of Al₂O₃ equivalent, the gel comprises from 0.2 to 2 moles of the SDA, more preferably from 0.5 to 1.8 moles of the SDA (i.e. “b” in the gel composition is from 0.1 to 2, preferably from 0.2 to 2, more preferably from 0.5 to 1.8). Accordingly, it is preferred that, relative to the molar amount of Al₂O₃ equivalent, the gel comprises at least 0.1 moles of the SDA, preferably at least 0.2 moles, more preferably at least 0.5 moles of the SDA. Similarly, it is preferred that, relative to the molar amount of Al₂O₃ equivalent, the gel comprises at most 1.9 moles of the SDA, more preferably at most 1.8 moles of the SDA.

In some preferred embodiments, the relative to the molar amount of Al₂O₃ equivalent, the gel from 0.5 to 1.5 moles of SDA, preferably from 0.8 to 1.2 moles, even more preferably 0.9 to 1.1 moles, for example, about 1 moles of SDA. Generally, lower amounts of SDA may be preferred in embodiments wherein one or more of the amount of SiO₂ equivalent, the total amount of Na₂O and K₂O equivalent (i.e. M₂O equivalent wherein M is Na and K insofar as either or both of Na and/or K are present), and the amount of water present in the reaction gel is within the generally higher amounts described herein.

It is particularly preferred that at least one of the amounts of SiO₂ equivalent, M₂O equivalent, and water are as described herein. The inventors has found that the combination of the amounts of each of these reaction gel components with the relatively low amount of SDA (i.e. from 0.1 to 2 moles relative to Al₂O₃) allows for an improvement in the synthesis of a low SAR CHA zeolite, particularly one having a low mesoporosity and/or a high crystallinity as described herein. More preferably, at least two of these parameters are used in combination with the amount of SDA, such as the amount of water which is preferably greater when the amount of SiO₂ equivalent is greater, and in a preferred embodiment, all of the amounts of SiO₂ equivalent, M₂O equivalent, and water fall within the ranges described herein.

It is particularly preferred that the M₂O equivalent, that is the total amount of Na₂O and K₂O equivalent (one or both may be present), relative to the molar amount of Al₂O₃ equivalent, is at least 3 or 4 moles, preferably from 3 to 15 moles, more preferably from 4 to 14 moles, more preferably from 4 to 13 moles. Equally, it may be said that “c” in the gel composition may be any of these ranges or values. For example, in some embodiments, higher amounts of M₂O equivalent are preferred such as at least 3 moles, more preferably at least 4 or 5 moles. In some particularly preferred embodiments, the amount of M₂O equivalent, relative to the molar amount of Al₂O₃ equivalent in the reaction gel is from 9 to 14 moles. Where lower amounts of M₂O equivalent are preferred, the amount of M₂O equivalent is preferably from 3 to 8 moles, preferably from 4 to 8 moles.

In some embodiments, it is preferred that, relative to the molar amount of Al₂O₃ equivalent, the gel comprises an amount of SiO₂ equivalent of at least 20 moles, preferably 20 to 50 moles, 20 to 40 moles, or 20 to 35 moles. Equally, it may be said that “a” in the gel composition may be any of these ranges or values. For example, in some embodiments, higher amounts of SiO₂ equivalent are preferred such as from 25 to 50 moles, preferably from 25 to 40 moles, or from 25 to 35 moles. In some preferred embodiments, about 20 moles of SiO₂ equivalent are preferred.

In some embodiments, it is preferred that, relative to the molar amount of Al₂O₃ equivalent, the gel comprises water and the water is present in an amount of at least 700 moles, preferably 750 to 1200 moles. Equally, it may be said that “d” in the gel composition may be any of these ranges or values. For example, in some embodiments, higher amounts of water are preferred (in particular where higher amounts of SiO₂ equivalent or M₂O equivalent are added) such as from 800 to 1150 moles, preferably from 900 to 1150 moles, such as about 1100 moles.

A particular advantage of the present method is that the inventors have found that the method does not require the use of seed crystals so as to form the desirable CHA zeolite. Accordingly, it is preferred that the reaction gel does not comprise seed crystals (i.e. CHA seed crystals).

Thus, in one particular preferred embodiment on the present invention, the gel consists of the structure directing agent (SDA), sodium and/or potassium hydroxide, the silica source, the alumina source and water, and, optionally, a further sodium and/or potassium salt.

In one preferred embodiment wherein the gel consists of the structure directing agent (SDA), sodium and/or potassium hydroxide, the silica source, the alumina source and water, relative to a molar amount of Al₂O₃ equivalent, the gel comprises from 0.5 to 1.8 moles of the SDA, from 4 to 13 moles of M₂O equivalent, from 20 to 40 moles of SiO₂ equivalent, and from 700 to 1100 moles of water.

The method of the present invention further comprises a step of heating the gel to a temperature and for a duration suitable for the growth of the CHA zeolite. Preferably, the temperature to which the heated is heated for such a suitable duration is from 100° C. to 200° C.; more preferably from 110° C. to 190° C., 120° C. to 180° C., 120° C. to 170° C., or even 125° C. to 165° C. The duration for which the gel is heated to a suitable temperature, is preferably at least 10 hours, more preferably, 20 to 60 hours. It is particularly preferred that the gel is heated to these temperatures and held at these temperatures for these durations, e.g. for at least 10 hours at a temperature of from 100° C. to 200° C.

Preferably, the zeolite product resulting from heating the reaction gel for such a temperature and duration is recovered by typical vacuum filtration. Preferably, the filtered product is washed with demineralized (also known as deionized) water is used to remove residual mother liquor. Preferably, the zeolite product is washed until the filtrate conductivity is below 0.1 mS. Preferably, the filtered and washed product is then dried at temperatures of greater than 100° C., preferably about 120° C.

In some preferred embodiments, the method further adding iron and/or copper to the zeolite by ion exchange. As described herein, iron and/or copper exchanged zeolites are particularly preferred as NH₃—SCR catalysts and the product obtained after growth of the CHA zeolite during the heating step may be ion exchanged with iron and/or copper to provide such an ion exchanged zeolite.

In a further aspect of the present invention, there is provided a catalyst article for the treatment of an exhaust gas, the catalyst article comprising the CHA zeolite as described herein.

In yet a further aspect, there is provided a method for the treatment of an exhaust gas, the method comprising contacting an exhaust gas with the catalyst article described herein.

### EXAMPLES

### General Procedure

Synthesis gel mixture is prepared by blending the selected raw materials at room temperature according to the synthesis gel composition. The resulting fluid mixture is then transferred into and sealed in an agitated reactor. In crystallization step, the synthesis gel is crystallized via hydrothermal treatment. The crystallization temperature is 120° C. to 165° C. depending on the gel composition. Crystallization is carried out with continuously mixing the synthesis gel by agitation. The amount of time for crystallization is from 10 hours to less than 100 hours.

After crystallization, the resulting zeolite product is recovered by typical vacuum filtration. In the washing step, demineralized water is used to remove residual mother liquor from solid product until the filtrate conductivity is below 0.1 mS. In the drying step, the moisture water of the filtered solid product is removed by drying overnight in a 120° C. oven.

### Example 1

4.76 g of aluminum hydroxide was dissolved under agitation in a solution prepared by blending 30.0 g of demineralized water and 18.76 g sodium hydroxide solution (50 wt %). To the resulting solution and under agitation, 242.3 g of additional demineralized water, 25.92 g of N,N,N-trimethyladamantylammonium hydroxide aqueous solution (25.5 wt %) and 78.3 g of silica sol (40 wt % Silica) were sequentially added. The resulting initial synthesis mixture was smooth slurry with a molar composition: 20.0SiO₂: 1.00Al₂O₃: 1.20TMAdOH: 4.50Na₂O: 750.0H₂O.

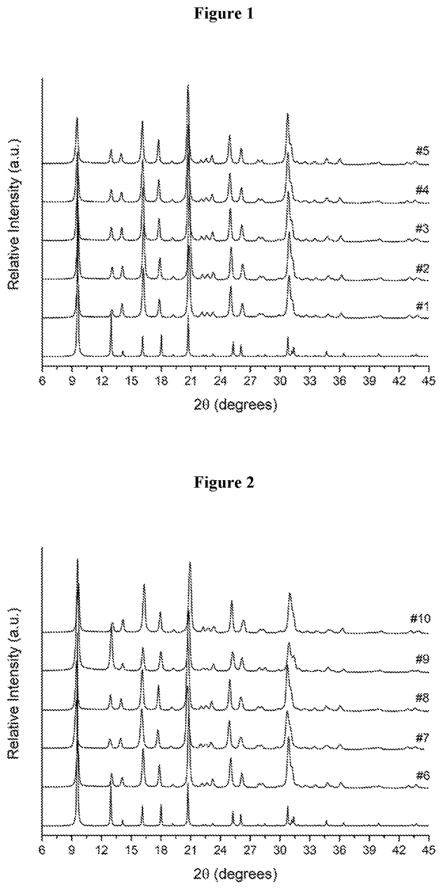

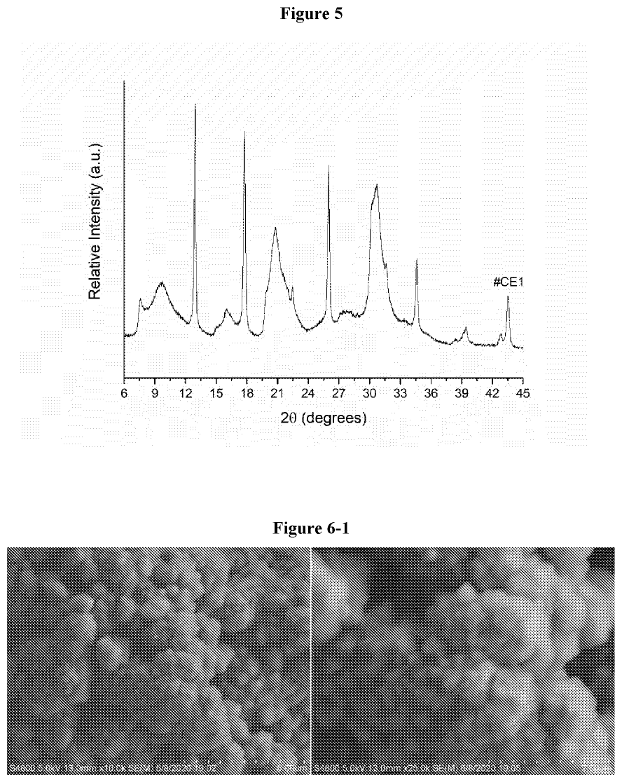

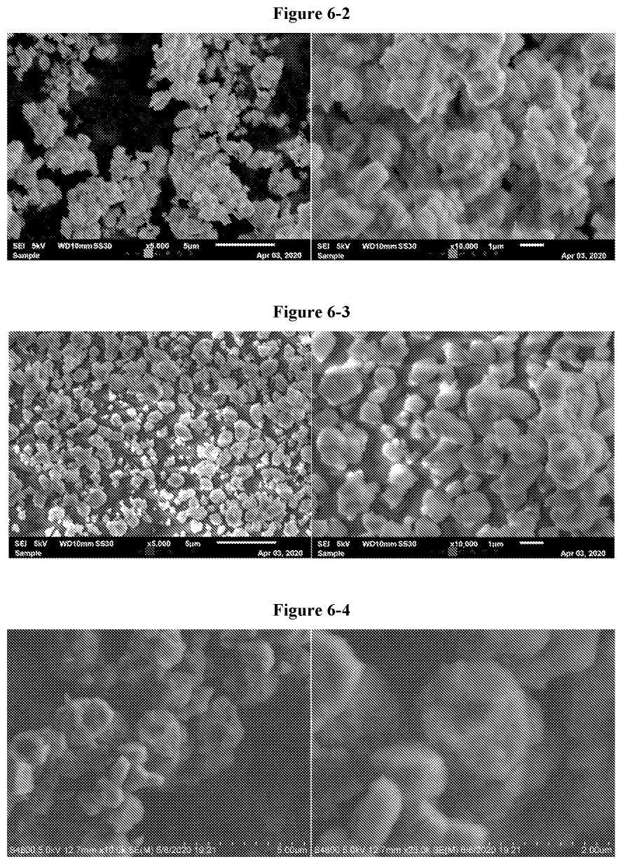

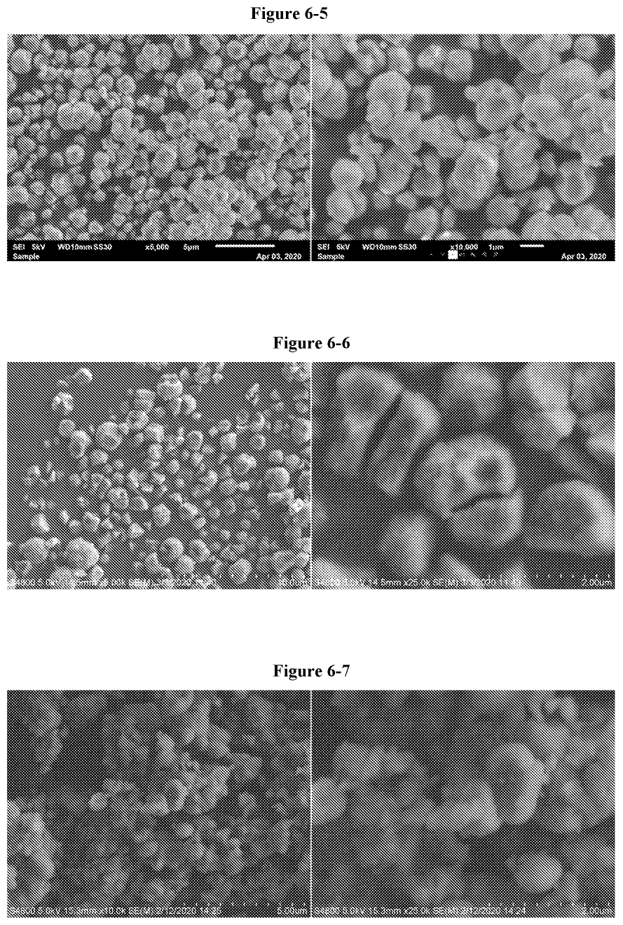

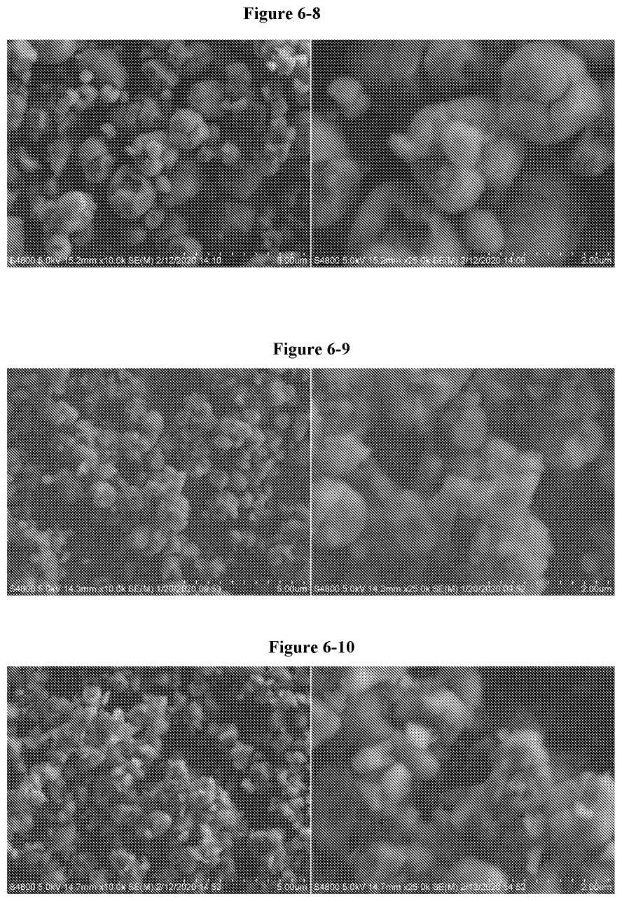

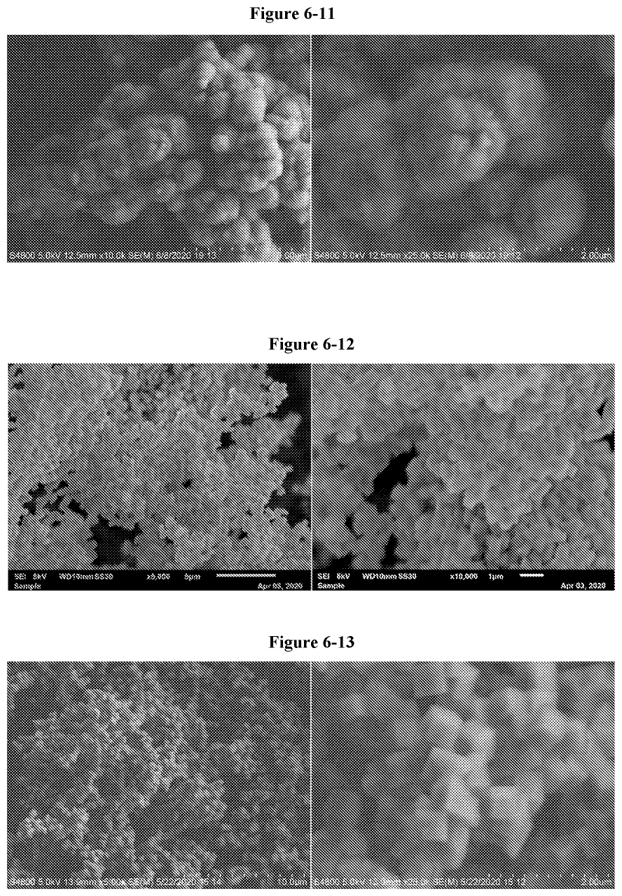

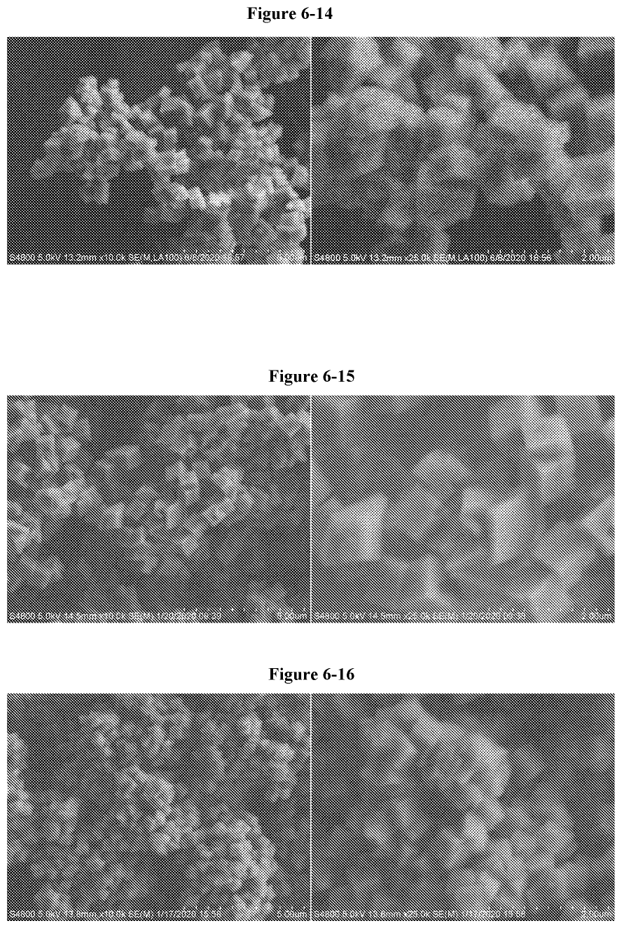

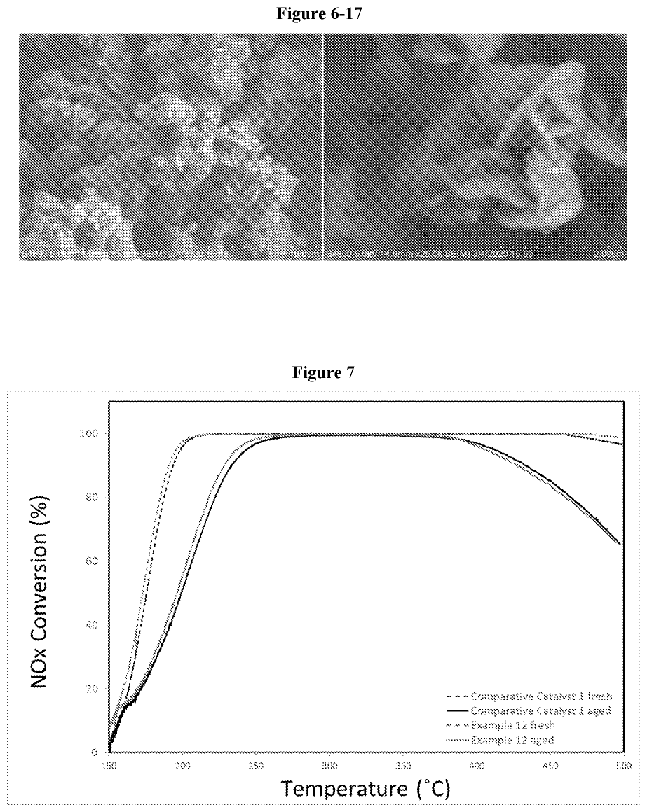

The initial gel mixture was sealed in a 600 mL stainless steel agitated autoclave and heated at heated at 165° C. for 54 hours of crystallization. The solid product was recovered by vacuum filtration, the obtained solid phase was washed with a sufficient amount of demineralized water, and dried overnight in a convention oven at 120° C. Based on powder X-ray diffraction (FIG. 1) and fluorescent X-ray analysis, the resulting product was a highly crystallized pure chabazite-type zeolite. The SiO₂/Al₂O₃ molar ratio of this chabazite-type zeolite was 14.7. The morphology of the crystal particle images was viewed by SEM (FIG. 6-1).

### Example 2

4.74 g of aluminum hydroxide was dissolved under agitation in a solution prepared by blending 30.0 g of demineralized water and 21.77 g of sodium hydroxide solution (50 wt %). To the resulting solution and under agitation, 235.6 g of additional demineralized water, 30.07 g of N,N,N-trimethyladamantylammonium hydroxide aqueous solution (25.5 wt %) and 77.8 g of silica sol (40 wt % Silica) were sequentially added. The resulting initial synthesis mixture was smooth slurry with a molar composition of: 20.0SiO₂: 1.00Al₂O₃: 1.40TMAdOH: 5.25Na₂O: 750.0H₂O.

The initial gel mixture was sealed in a 600 mL stainless steel agitated autoclave and heated at heated at 165° C. for 22 hours of crystallization. The solid product was recovered by vacuum filtration, the obtained solid phase was washed with a sufficient amount of demineralized water, and dried overnight in a convention oven at 120° C. Based on powder X-ray diffraction (FIG. 1) and fluorescent X-ray analysis, the resulting product was a highly crystallized pure chabazite-type zeolite. The SiO₂/Al₂O₃ molar ratio of this chabazite-type zeolite was 12.5. The morphology of the crystal particle images was viewed by SEM (FIG. 6-2).

### Example 3

3.53 g of aluminum hydroxide was dissolved under agitation in a solution prepared by blending 30.0 g of demineralized water and 18.55 g of sodium hydroxide solution (50 wt %). To the resulting solution and under agitation, 164.3 g of additional demineralized water, 25.63 g of N,N,N-trimethyladamantylammonium hydroxide aqueous solution (25.5 wt %) and 58.0 g of silica sol (40 wt % Silica) were sequentially added. The resulting initial synthesis mixture was smooth slurry with a molar composition of: 20.0SiO₂: 1.00Al₂O₃: 1.60TMAdOH: 6.00Na₂O: 750.0H₂O.

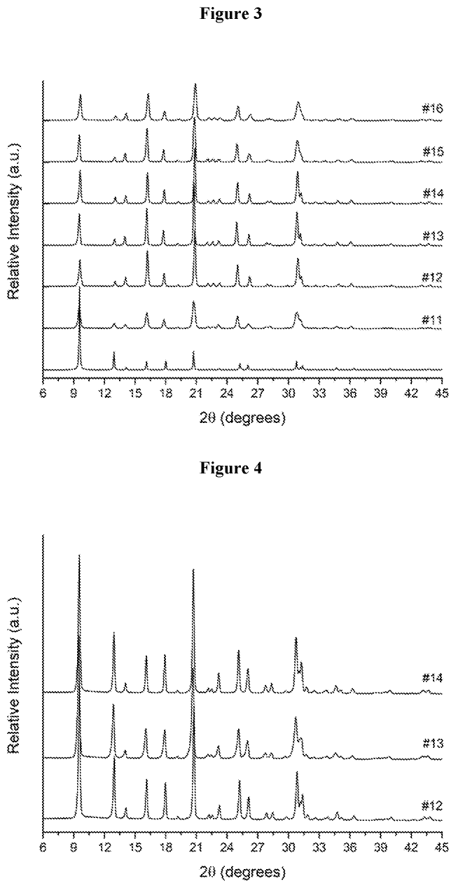

The initial gel mixture was sealed in a 600 mL stainless steel agitated autoclave and heated at heated at 165° C. for 24 hours of crystallization. The solid product was recovered by vacuum filtration, the obtained solid phase was washed with a sufficient amount of demineralized water, and dried overnight in a convention oven at 120° C. Based on powder X-ray diffraction (FIG. 1) and fluorescent X-ray analysis, the resulting product was a highly crystallized pure chabazite-type zeolite. The SiO₂/Al₂O₃ molar ratio of this chabazite-type zeolite was 11.2. The morphology of the crystal particle images was viewed by SEM (FIG. 6-3).

### Example 4

18.90 g of aluminum hydroxide was dissolved under agitation in a solution prepared by blending 120.0 g of demineralized water and 105.9 g sodium hydroxide solution (50 wt %). To the resulting solution and under agitation, 941.5 g of additional demineralized water, 102.9 g of N,N,N-trimethyladamantylammonium hydroxide aqueous solution (25.5 wt %) and 310.8 g of silica sol (40 wt % Silica) were sequentially added. The resulting initial synthesis mixture was smooth slurry with a molar composition of: 20.0SiO₂: 1.00Al₂O₃: 1.20TMAdOH: 6.40Na₂O: 750.0H₂O.

The initial gel mixture was sealed in a 2000 mL stainless steel agitated autoclave and heated at heated at 160° C. for 47 hours of crystallization. The solid product was recovered by vacuum filtration, the obtained solid phase was washed with a sufficient amount of demineralized water, and dried overnight in a convention oven at 120° C. Based on powder X-ray diffraction (FIG. 1) and fluorescent X-ray analysis, the resulting product was a highly crystallized pure chabazite-type zeolite. The SiO₂/Al₂O₃ molar ratio of this chabazite-type zeolite was 10.8. The morphology of the crystal particle images was viewed by SEM (FIG. 6-4).

### Example 5

3.51 g of aluminum hydroxide was dissolved under agitation in a solution prepared by blending 30.0 g of demineralized water and 20.75 g of sodium hydroxide solution (50 wt %). To the resulting solution and under agitation, 159.4 g of additional demineralized water, 28.66 g of N,N,N-trimethyladamantylammonium hydroxide aqueous solution (25.5 wt %) and 57.7 g of silica sol (40 wt % Silica) were sequentially added. The resulting initial synthesis mixture was smooth slurry with a molar composition of: 20.0SiO₂: 1.00Al₂O₃: 1.80TMAdOH: 6.75Na₂O: 750.0H₂O.

The initial gel mixture was sealed in a 600 mL stainless steel agitated autoclave and heated at heated at 125° C. for 42 hours of crystallization. The solid product was recovered by vacuum filtration, the obtained solid phase was washed with a sufficient amount of demineralized water, and dried overnight in a convention oven at 120° C. Based on powder X-ray diffraction (FIG. 1) and fluorescent X-ray analysis, the resulting product was a highly crystallized pure chabazite-type zeolite. The SiO₂/Al₂O₃ molar ratio of this chabazite-type zeolite was 9.1. The morphology of the crystal particle images was viewed by SEM (FIG. 6-5).

### Example 6

3.35 g of aluminum hydroxide was dissolved under agitation in a solution prepared by blending 30.0 g of demineralized water and 20.54 g of sodium hydroxide solution (50 wt %). To the resulting solution and under agitation, 175.8 g of additional demineralized water, 15.197 g of N,N,N-trimethyladamantylammonium hydroxide aqueous solution (25.5 wt %) and 55.1 g of silica sol (40 wt % Silica) were sequentially added. The resulting initial synthesis mixture was smooth slurry with a molar composition of: 20.0SiO₂: 1.00Al₂O₃: 1.00TMAdOH: 7.00Na₂O: 800.0H₂O.

The initial gel mixture was sealed in a 600 mL stainless steel agitated autoclave and heated at heated at 145° C. for 24 hours of crystallization. The solid product was recovered by vacuum filtration, the obtained solid phase was washed with a sufficient amount of demineralized water, and dried overnight in a convention oven at 120° C. Based on powder X-ray diffraction (FIG. 2) and fluorescent X-ray analysis, the resulting product was a highly crystallized pure chabazite-type zeolite. The SiO₂/Al₂O₃ molar ratio of this chabazite-type zeolite was 9.3. The morphology of the crystal particle images was viewed by SEM (FIG. 6-6).

### Example 7

A solution was prepared under agitation by blending of 187.6 g of demineralized water, 25.4 g of sodium hydroxide solution (50 wt %) and 10.97 g of N,N,N-trimethyladamantylammonium hydroxide aqueous solution (25.5 wt %). 16.45 g of aluminum sulfate solution (8.2% Al₂O₃) and 59.6 g of silica sol (40 wt % Silica) were sequentially added to the solution. The resulting initial synthesis mixture was smooth slurry with a molar composition of: 30.0SiO₂: 1.00Al₂O₃: 1.00TMAdOH: 9.0Na₂O: 3.00Na₂SO₄: 1100.0H₂O.

The initial gel mixture was sealed in a 600 mL stainless steel agitated autoclave and heated at heated at 145° C. for 26 hours of crystallization. The solid product was recovered by vacuum filtration, the obtained solid phase was washed with a sufficient amount of demineralized water, and dried overnight in a convention oven at 120° C. Based on powder X-ray diffraction (FIG. 2) and fluorescent X-ray analysis, the resulting product was a highly crystallized pure chabazite-type zeolite. The SiO₂/Al₂O₃ molar ratio of this chabazite-type zeolite was 12.7. The morphology of the crystal particle images was viewed by SEM (FIG. 6-7).

### Example 8

A solution was prepared under agitation by blending of 185.4 of demineralized water, 27.44 of sodium hydroxide solution (50 wt %) and 10.94 g of N,N,N-trimethyladamantylammonium hydroxide aqueous solution (25.5 wt %). 16.82 g of aluminum sulfate solution (8.2% Al₂O₃) and 59.5 g of silica sol (40 wt % Silica) were sequentially added to the solution. The resulting initial synthesis mixture was smooth slurry with a molar composition of: 30.0SiO₂: 1.00Al₂O₃: 1.00TMAdOH: 10.0Na₂O: 3.00Na₂SO₄: 1100.0H₂O.

The initial gel mixture was sealed in a 600 mL stainless steel agitated autoclave and heated at heated at 145° C. for 24 hours of crystallization. The solid product was recovered by vacuum filtration, the obtained solid phase was washed with a sufficient amount of demineralized water, and dried overnight in a convention oven at 120° C. Based on powder X-ray diffraction (FIG. 2) and fluorescent X-ray analysis, the resulting product was a highly crystallized pure chabazite-type zeolite. The SiO₂/Al₂O₃ molar ratio of this chabazite-type zeolite was 9.9. The morphology of the crystal particle images was viewed by SEM (FIG. 6-8).

### Example 9

A solution was prepared under agitation by blending of 182.6 g of demineralized water, 6.263 of sodium hydroxide solution (50 wt %) and 12.05 g of N,N,N-trimethyladamantylammonium hydroxide aqueous solution (25.5 wt %). 16.43 of aluminum sulfate solution (8.2% Al₂O₃) and 82.7 g of sodium silicate (9.0% Na₂O and 28.8% SiO₂) were sequentially added to the solution. The resulting initial synthesis mixture was smooth slurry with a molar composition of: 30.0SiO₂: 1.00Al₂O₃: 1.1TMAdOH: 9.05Na₂O: 3.00Na₂SO₄: 1100.0H₂O.

The initial gel mixture was sealed in a 600 mL stainless steel agitated autoclave and heated at heated at 145° C. for 24 hours of crystallization. The solid product was recovered by vacuum filtration, the obtained solid phase was washed with a sufficient amount of demineralized water, and dried overnight in a convention oven at 120° C. Based on powder X-ray diffraction (FIG. 2) and fluorescent X-ray analysis, the resulting product was a highly crystallized pure chabazite-type zeolite. The SiO₂/Al₂O₃ molar ratio of this chabazite-type zeolite was 13.3. The morphology of the crystal particle images was viewed by SEM (FIG. 6-9).

### Example 10

2.44 g of aluminum hydroxide was dissolved under agitation in a solution prepared by blending 30.0 g of demineralized water and 19.21 g of sodium hydroxide solution (50 wt %). To the resulting solution and under agitation, 177.2 g of additional demineralized water, 11.06 g of N,N,N-trimethyladamantylammonium hydroxide aqueous solution (25.5 wt %) and 60.1 g of silica sol (40 wt % Silica) were sequentially added. The resulting initial synthesis mixture was smooth slurry with a molar composition of: 30.0SiO₂: 1.00Al₂O₃: 1.0TMAdOH: 9.00Na₂O: 1100.0H₂O.

The initial gel mixture was sealed in a 600 mL stainless steel agitated autoclave and heated at heated at 145° C. for 51 hours of crystallization. The solid product was recovered by vacuum filtration, the obtained solid phase was washed with a sufficient amount of demineralized water, and dried overnight in a convention oven at 120° C. Based on powder X-ray diffraction (FIG. 2) and fluorescent X-ray analysis, the resulting product was a highly crystallized pure chabazite-type zeolite. The SiO₂/Al₂O₃ molar ratio of this chabazite-type zeolite was 13.2. The morphology of the crystal particle images was viewed by SEM (FIG. 6-10).

### Example 11

4.65 g of aluminum hydroxide was dissolved under agitation in a solution prepared by blending 40.0 g of demineralized water, 3.81 g of potassium hydroxide solution (45%) and 28.12 g of sodium hydroxide solution (50 wt %). To the resulting solution and under agitation, 217.2 g of additional demineralized water, 10.55 g of N,N,N-trimethyladamantylammonium hydroxide aqueous solution (25.5 wt %) and 95.63 g of silica sol (40 wt % Silica) were sequentially added. The resulting initial synthesis mixture was smooth slurry with a molar composition of: 25.0SiO₂: 1.00Al₂O₃: 0.5TMAdOH: 6.9Na₂O: 0.6K₂O: 750.0H₂O.

The initial gel mixture was sealed in a 600 mL stainless steel agitated autoclave and heated at heated at 155° C. for 46 hours of crystallization. The solid product was recovered by vacuum filtration, the obtained solid phase was washed with a sufficient amount of demineralized water, and dried overnight in a convention oven at 120° C. Based on powder X-ray diffraction (FIG. 3) and fluorescent X-ray analysis, the resulting product was a highly crystallized pure chabazite-type zeolite. The SiO₂/Al₂O₃ molar ratio of this chabazite-type zeolite was 10.7. The morphology of the crystal particle images was viewed by SEM (FIG. 6-11).

### Example 12

96.6 g of USY (CBV720, Zeolyst) was mixed under agitation in 799.3 g of demineralized water. To the resulting mixture and under agitation, 36.78 g of N,N,N-trimethyladamantylammonium hydroxide aqueous solution (25.5 wt %) and 67.4 g of sodium hydroxide solution (50 wt %) were added. The resulting initial synthesis mixture had a molar composition of: 30.2SiO₂: 1.00Al₂O₃: 1.0TMAdOH: 9.5Na₂O: 1100.0H₂O.

The initial gel mixture was sealed in a 2000 mL stainless steel agitated autoclave and heated at heated at 145° C. for 21 hours of crystallization. The solid product was recovered by vacuum filtration, the obtained solid phase was washed with a sufficient amount of demineralized water, and dried overnight in a convention oven at 120° C. Based on powder X-ray diffraction (FIG. 3) and fluorescent X-ray analysis, the resulting product was a highly crystallized pure chabazite-type zeolite. The SiO₂/Al₂O₃ molar ratio of this chabazite-type zeolite was 13.0. The morphology of the crystal particle images was viewed by SEM (FIG. 6-12).

The as-synthesized solid product was calcined inside a muffle furnace heated to 550° C. with a ramping rate of 1° C./min and held at 550° C. for six hours.

The calcined product was cooled and then ammonium exchanged two times. Ammonium sulfate was used, and the ion exchange took place at 80° C. for two hours. The solid product was recovered by filtration and after washing the filter cake was dried at 120° C. The resulting NH₄-form dry product was calcined inside a muffle furnace heated with a ramping rate of 1° C./min and held at 550° C. for two hours. The final resulting product is an activated H-form zeolite. The final product exhibited the X-ray diffraction pattern of highly crystallized pure CHA structure (FIG. 4) indicating that the material remains stable after calcination to remove the organic template, ion exchange to remove alkali cation and final activation to convert from NH₄-form to H-form.

BET surface area, mesopore surface area, and micropore volume measurements of the activated product listed in Table 1 were extracted from the Ar adsorption isotherms collected at 87K using a Micromeritics 3-Flex apparatus.

### Example 13

42.4 g of USY (CBV720, Zeolyst) was mixed under agitation in 308.5 g of demineralized water. To the resulting mixture and under agitation, 15.93 g of N,N,N-trimethyladamantylammonium hydroxide aqueous solution (25.5 wt %) and 33.17 g of sodium hydroxide solution (50 wt %) were added. The resulting initial synthesis mixture had a molar composition of: 30.2SiO₂: 1.00Al₂O₃: 1.0TMAdOH: 10.8Na₂O: 1000.0H₂O.

The initial gel mixture was sealed in a 600 mL stainless steel agitated autoclave and heated at heated at 145° C. for 17 hours of crystallization. The solid product was recovered by vacuum filtration, the obtained solid phase was washed with a sufficient amount of demineralized water, and dried overnight in a convention oven at 120° C. Based on powder X-ray diffraction (FIG. 3) and fluorescent X-ray analysis, the resulting product was a highly crystallized pure chabazite-type zeolite. The SiO₂/Al₂O₃ molar ratio of this chabazite-type zeolite was 11.0. The morphology of the crystal particle images was viewed by SEM (FIG. 6-13). The as synthesized solid product was activated following the procedure described in Example 12. The final product exhibited the X-ray diffraction pattern of highly crystallized pure CHA structure (FIG. 4) indicating that the material remains stable after calcination to remove the organic template, ion exchange to remove alkali cation and final activation to convert from NH₄-form to H-form.

### Example 14

47.5 g of USY (CBV720, Zeolyst) was mixed under agitation in 303.2 g of demineralized water. To the resulting mixture and under agitation, 11.00 g of N,N,N-trimethyladamantylammonium hydroxide aqueous solution (25.5 wt %) and 38.24 g of sodium hydroxide solution (50 wt %) were added. The resulting initial synthesis mixture had a molar composition of: 34.0SiO₂: 1.00Al₂O₃: 0.70TMAdOH: 12.6Na₂O: 1000.0H₂O.

The initial gel mixture was sealed in a 600 mL stainless steel agitated autoclave and heated at heated at 130° C. for 30 hours of crystallization. The solid product was recovered by vacuum filtration, the obtained solid phase was washed with a sufficient amount of demineralized water, and dried overnight in a convention oven at 120° C. Based on powder X-ray diffraction (FIG. 3) and fluorescent X-ray analysis, the resulting product was a highly crystallized pure chabazite-type zeolite. The SiO₂/Al₂O₃ molar ratio of this chabazite-type zeolite was 9.3. The morphology of the crystal particle images was viewed by SEM (FIG. 6-14). The as synthesized solid product was activated following the procedure described in Example 12. The final product exhibited the X-ray diffraction pattern of highly crystallized pure CHA structure (FIG. 4) indicating that the material remains stable after calcination to remove the organic template, ion exchange to remove alkali cation and final activation to convert from NH₄-form to H-form.

### Example 15

12.50 g of USY (CBV712, Zeolyst) was mixed under agitation in 219.2 g of demineralized water. To the resulting mixture and under agitation, 11.03 g of N,N,N-trimethyladamantylammonium hydroxide aqueous solution (25.5 wt %), 21.28 g of sodium hydroxide solution (50 wt %) and lastly 36.0 g of silica sol (40 wt % Silica) were added. The resulting initial synthesis mixture had a molar composition of: 30.0SiO₂: 1.00Al₂O₃: 1.0TMAdOH: 10.0Na₂O: 1100.0H₂O.

The initial gel mixture was sealed in a 600 mL stainless steel agitated autoclave and heated at heated at 145° C. for 24 hours of crystallization. The solid product was recovered by vacuum filtration, the obtained solid phase was washed with a sufficient amount of demineralized water, and dried overnight in a convention oven at 120° C. Based on powder X-ray diffraction (FIG. 3) and fluorescent X-ray analysis, the resulting product was a highly crystallized pure chabazite-type zeolite. The SiO₂/Al₂O₃ molar ratio of this chabazite-type zeolite was 12.7. The morphology of the crystal particle images was viewed by SEM (FIG. 6-15).

### Example 16

7.78 g of USY (CBV500, Zeolyst) was mixed under agitation in 210.9 g of demineralized water. To the resulting mixture and under agitation, 11.03 g of N,N,N-trimethyladamantylammonium hydroxide aqueous solution (25.5 wt %), 21.28 g of sodium hydroxide solution (50 wt %) and lastly 49.07 g of silica sol (40 wt % Silica) were added. The resulting initial synthesis mixture had a molar composition of: 30.0SiO₂: 1.00Al₂O₃: 1.0TMAdOH: 10.0Na₂O: 1100.0H₂O.

The initial gel mixture was sealed in a 600 mL stainless steel agitated autoclave and heated at heated at 145° C. for 24 hours of crystallization. The solid product was recovered by vacuum filtration, the obtained solid phase was washed with a sufficient amount of demineralized water, and dried overnight in a convention oven at 120° C. Based on powder X-ray diffraction (FIG. 3) and fluorescent X-ray analysis, the resulting product was a highly crystallized pure chabazite-type zeolite. The SiO₂/Al₂O₃ molar ratio of this chabazite-type zeolite was 13.0. The morphology of the crystal particle images was viewed by SEM (FIG. 6-16).

### Comparative Example 1

3.81 g of aluminum hydroxide was dissolved under agitation in a solution prepared by blending 30.0 g of demineralized water and 25.03 g of sodium hydroxide solution (50 wt %). To the resulting solution and under agitation, 178.48 g of additional demineralized water and 62.7 g of silica sol (40 wt % Silica) were sequentially add. The resulting initial synthesis mixture had the following molar compositions: 20.0SiO₂: 1.00Al₂O₃: 7.50Na₂O: 700.0H₂O.

The initial gel mixture was sealed in a 600 mL stainless steel agitated autoclave and heated at heated at 125° C. for 27 hours of crystallization. The solid product was recovered by vacuum filtration, the obtained solid phase was washed with a sufficient amount of demineralized water, and dried overnight in a convention oven at 120° C. Based on powder X-ray diffraction (FIG. 5) and fluorescent X-ray analysis, the resulting product was an intergrowth of GME and CHA structure. The SiO₂/Al₂O₃ molar ratio of this chabazite-type zeolite was 7.2. The morphology of the crystal particle images was viewed by SEM (FIG. 6-17).

Examples 1-16 and Comparative Example 1 are summarised in Table 1.

TABLE 1

| | | | | | Porosity by Ar adsorption^{c} | | |
|---|---|---|---|---|---|---|---|
| | | Resulting solid product | | | | Mesopore | |
| | | | | Average | BET | surface | Micropore |
| Example | Gel composition | | | crystal | area^{d} | area^{e} | volume^{e} |
| No. | (normalized to 1.00 Al₂O₃) | SAR^{a} | Morphology^{b} | size^{b} μm | m²/g | m²/g | cm³/g |
| 1 | 20.0SiO₂:1.20TMAdOH:4.50Na₂O:750.0H₂O | 14.7 | Granular | 0.2-1 | — | — | — |
| 2 | 20.0SiO₂:1.40TMAdOH:5.25Na₂O:750.0H₂O | 12.5 | Granular | 1 | 689 | 33 | 0.23 |
| 3 | 20.0SiO₂:1.60TMAdOH:6.00Na₂O:750.0H₂O | 11.2 | Granular | 1-2 | — | — | — |
| 4 | 20.0SiO₂:1.20TMAdOH:6.40Na₂O:750.0H₂O | 10.8 | Granular | 1-2 | 674 | 3 | 0.23 |
| 5 | 20.0SiO₂:1.80TMAdOH:6.75Na₂O:750.0H₂O | 9.1 | Granular | 1-3 | 651 | 5 | 0.23 |
| 6 | 20.0SiO₂:1.00TMAdOH:7.00Na₂O:800.0H₂O | 9.3 | Granular | 2-5 | — | — | — |
| 7 | 30.0SiO₂:1.00TMAdOH:9.00Na₂O:3.00Na₂SO₄:1100.0H₂O | 12.7 | Granular | 0.5-1 | 695 | 25 | 0.24 |
| 8 | 30.0SiO₂:1.00TMAdOH:10.0Na₂O:3.00Na₂SO₄:1000.0H₂O | 9.9 | Granular | 1-4 | — | — | — |
| 9 | 30.0SiO₂:1.10TMAdOH:9.05Na₂O:3.00Na₂SO₄:1100.0H₂O | 13.3 | Granular | 1-2 | — | — | — |
| 10 | 30.0SiO₂:1.00TMAdOH:9.00Na₂O:1100.0H₂O | 13.2 | Granular | 0.5-2 | — | — | — |
| 11 | 25.0SiO₂:0.50TMAdOH:6.9Na₂O:0.6K₂O:750.0H₂O | 10.7 | Granular | 1-3 | | | |
| 12 | 30.2SiO₂:1.00TMAdOH:9.5Na₂O:1100.0H₂O | 13.0 | Cubic | 0.5-1 | 709 | 6 | 0.24 |
| 13 | 30.2SiO₂:1.00TMAdOH:10.8Na₂O:1000.0H₂O | 11.0 | Cubic | 0.5-1 | 698 | 5 | 0.23 |
| 14 | 34.0SiO₂:0.70TMAdOH:12.6Na₂O:1000.0H₂O | 9.3 | Cubic | 0.5-1 | 797 | 10 | 0.26 |
| 15 | 30.0SiO₂:1.00TMAdOH:10.0Na₂O:1100.0H₂O | 12.7 | Cubic | 0.5-1 | — | — | — |
| 16 | 30.0SiO₂:1.00TMAdOH:10.0Na₂O:1100.0H₂O | 13.0 | Cubic | 0.5-1 | — | — | — |
| Comparative | 20.0SiO₂:0.00TMAdOH:7.5Na₂O:700.0H₂O | 7.2 | Disk-cluster | 1-2 | — | — | — |
| Example 1 | | | | | | | |

^{a}by X-ray fluorescence analysis.
^{b}by scanning electron microscopy images.
^{c}Measured on the activated samples (H-form).
^{d}Apparent BET surface area derived using Rouquerol optimisation method.
^{e}Micropore volume, micropore and mesopore surface areas assessed by t-plot using silica t curves.

### Catalysts Performance Testing

Comparative Catalyst 1 and Comparative Catalyst 2 are two commercially available CHA zeolites in H-form with SAR of 13 and 10, respectively.

Activated zeolites prepared following the procedure described for Examples 12, 13 and 14 and Comparative Catalysts 1 and 2 were impregnated with metal using the required amount of copper (II) acetate dissolved in de-mineralized water. The metal impregnated zeolite was dried for 3 hours at 105° C. and then calcined in air at 500° C. for 2 hours. Copper was added to the zeolite to achieve 3.0 wt. % copper based on the total weight of the zeolite.

Each sample was pelletized and tested using a gas flow comprising 500 ppm NO, 550 ppm NH₃, 10% H₂O and 10% O₂. The amount of each catalyst employed in the tests was 0.3 g. The flow rate of the gas flow employed in the tests was 2.6 L/min, which equates to 520 L/hour per gram of catalyst. The sample was heated from room temperature to 150° C. under nitrogen and then exposed to the above gas mixture for 1 minute. The temperature was then increased from 150° C. to 500° C. at a rate of 5° C./minute. The downstream gas treated by the zeolite was monitored to determine NOₓ conversion.

A portion of the Cu impregnated samples were hydrothermally aged at 850° C. for 16 hours in air with 10% H₂O by volume. These samples were tested on the rig under conditions similar to those described above for the fresh samples.

As shown in FIG. 7, catalysts formed according to the method of the present invention and containing 3.0 wt % of copper with a SAR of 13.0 (Example 12) demonstrated an improved low temperature (<250° C.) NOₓ conversion both fresh and after hydrothermal aging compared to Comparative Catalyst 1 which employ a CuCHA zeolite with approximately the same SAR of 13.

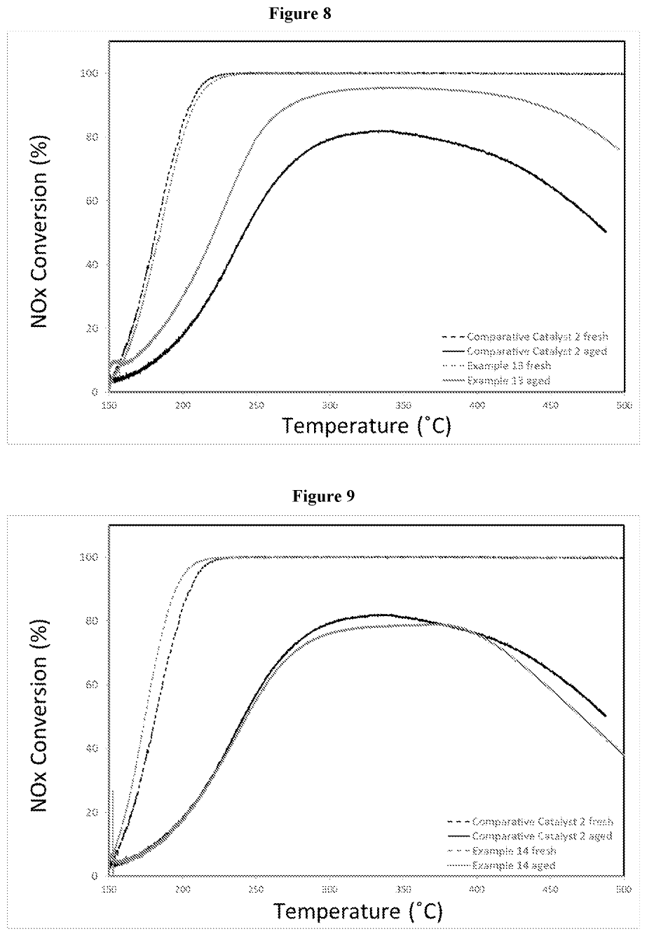

As shown in FIG. 8, catalysts formed according to the method of the present invention and containing 3.0 wt % of copper with a SAR of 11.0 (Example 13) demonstrated a slightly lower low temperature (<250° C.) fresh NOₓ conversion compared to Comparative Catalyst 2 which employ a CuCHA zeolite with approximately the same SAR of 10. However, after hydrothermal aging at 850° C. for 16 hours, the catalyst formed following Example 13 demonstrate significantly improved NOₓ conversion over the temperature range of 150 to 500° C.

As shown in FIG. 9, catalysts formed according to the method of the present invention and containing 3.0 wt % of copper with a SAR of 9.3 (Example 14) demonstrated a significantly improved low temperature (>225° C.) fresh NOₓ conversion compared to Comparative Catalyst 2 which employ a CuCHA zeolite with approximately the same SAR of 10. After hydrothermal aging at 850° C. for 16 hours, the catalyst formed following Example 13 demonstrate slightly lower NOₓ conversion after 225° C. compared to the comparative catalyst.

As used herein, the singular form of “a”, “an” and “the” include plural references unless the context clearly dictates otherwise. The use of the term “comprising” is intended to be interpreted as including such features but not excluding other features and is also intended to include the option of the features necessarily being limited to those described. In other words, the term also includes the limitations of “consisting essentially of” (intended to mean that specific further components can be present provided they do not materially affect the essential characteristic of the described feature) and “consisting of” (intended to mean that no other feature may be included such that if the components were expressed as percentages by their proportions, these would add up to 100%, whilst accounting for any unavoidable impurities), unless the context clearly dictates otherwise.

The foregoing detailed description has been provided by way of explanation and illustration, and is not intended to limit the scope of the appended claims. Many variations of the presently preferred embodiments illustrated herein will be apparent to one of ordinary skill in the art, and remain within the scope of the appended claims and their equivalents.

1. A chabazite (CHA) zeolite having an SAR of from 7 to 15, and at least one following features: (a) a mesoporous surface area of less than 35 m²/g; (b) a BET surface area of 500-800 m²/g; and/or (c) a micropore volume of 0.2-0.3 cm²/g.

2. The CHA zeolite according to claim 1, wherein the SAR is from 7 to 13, preferably 8 to 12.

3. The CHA zeolite according to claim 1, wherein the zeolite has a crystallinity of greater than 95%.

4. The CHA zeolite according to claim 1, having a granular particle comprising cubic crystals.

5. The CHA zeolite according to claim 1, having a mean longest edge crystal size of no greater than 6 microns.

6. A method for the manufacture of a chabazite (CHA) zeolite having an SAR of from 7 to 15, the method comprising:
(i) forming a reaction gel comprising a structure directing agent (SDA), sodium and/or potassium hydroxide, a silica source and an alumina source, and
(ii) heating the gel to a temperature and for a duration suitable for the growth of the CHA zeolite,
wherein, relative to a molar amount of Al₂O₃ equivalent, the gel comprises from 0.1 to 2 moles of the SDA, and wherein the SDA cation is N,N,N-trimethyladamantylammonium.

7. The method according to claim 6, wherein, relative to the molar amount of Al₂O₃ equivalent, the gel comprises from 0.5 to 1.8 moles of the SDA.

8. The method according to claim 6, wherein, relative to the molar amount of Al₂O₃ equivalent, the gel comprises water and the water is present in an amount of 750 to 1200 moles.

9. The method according to claim 6, wherein, relative to the molar amount of Al₂O₃ equivalent, the gel comprises an amount of SiO₂ equivalent of 20 to 50 moles.

10. The method according to claim 6, wherein, relative to the molar amount of Al₂O₃ equivalent, the gel comprises a total amount of Na₂O and K₂O equivalent of 3 to 15 moles.

11. The method according to claim 6, wherein the reaction gel does not comprise CHA seed crystals.

12. The method according to claim 6, wherein the gel consists of the structure directing agent (SDA), sodium and/or potassium hydroxide, the silica source, the alumina source and water.

13. The method according to claim 6, wherein the temperature is from 110° C. to 190° C.

14. The method according to claim 6, wherein the duration is 20 to 60 hours.

15. The method according to claim 6 wherein the alumina source is selected from FAU zeolite, USY zeolite, Al(OH)₃, and Al₂(SO₄)₃.

16. The method according to claim 6, wherein the method further comprises adding iron and/or copper to the zeolite by ion exchange.

17. (canceled)

18. A catalyst article for the treatment of an exhaust gas, the catalyst article comprising the CHA zeolite according to claim 1.

19. A method for the treatment of an exhaust gas, the method comprising contacting an exhaust gas with the catalyst article according to claim 18.

20. A catalyst article for the treatment of an exhaust gas, the catalyst article comprising the CHA zeolite prepared by the method according to claim 6.

21. A method for the treatment of an exhaust gas, the method comprising contacting an exhaust gas with the catalyst article according to claim 20.
